(19) United States
(12) Patent Application Publication
(10) Pub. No.: US 2025/0189658 A1
(43) Pub. Date: Jun. 12, 2025

(54) SENSOR FUSION AND OBJECT TRACKING SYSTEM AND METHOD THEREOF

(71) Applicant: Automotive Research & Testing Center, Lugang (TW)

(72) Inventors: Yun-Ling CHANG, Lugang (TW); Shih-Hsuan LIN, Lugang (TW)

(73) Assignee: Automotive Research & Testing Center, Lugang (TW)

(21) Appl. No.: 18/535,792

(22) Filed: Dec. 11, 2023

(51) Int. Cl. G01S 13/86; G01S 13/72; G01S 13/89; G01S 13/931

(52) U.S. Cl. CPC G01S 13/865; G01S 13/72; G01S 13/89; G01S 13/931

(57) ABSTRACT

A sensor fusion and object tracking system and a method thereof are provided. The sensor fusion and object tracking system includes a first fusion module and a second fusion module in signal communication therewith. The first fusion module performs a first fusion process on a 2D driving image and 3D point cloud information to obtain first fusion information having a plurality of recognized objects. The second fusion module performs a second fusion process on the first fusion information and radar information to obtain second fusion information containing the plurality of recognized objects. The second fusion information is used to generate a region of interest (ROI), and the recognized objects within the ROI serve as target objects in subsequent tracking.

### BACKGROUND OF THE INVENTION

### Field of the Invention

The present invention relates to an object tracking system and a method thereof, particularly to a sensor fusion and object tracking system and a method thereof.

### Description of the Prior Art

With fast development of science and technology, autonomous driving technology is also advancing persistently. The Society of Automotive Engineers (SAE) divides the autonomous driving systems into Level 0-Level 5. The Level 2-Level 4 autonomous driving systems need the information of various sensors for comparing, integrating and outputting the information to enable the subsequent control operations. Among the detection technologies for detecting barriers around the vehicle, the development of the multi-sensor fusion system for fusing information of various sensors is particularly important.

In general, the autonomous driving system will use sensors, such as radar, lidar, and cameras to detect barriers so as to dodge the barriers or stop the vehicle for the barriers while the vehicle is running. However, the sensors are hard to integrate because they are different in field of view, distance measurement, analysis precision, etc.

### SUMMARY OF THE INVENTION

One object of the present invention provides a sensor fusion and object tracking system and a method thereof, which can detect and track objects stably.

The sensor fusion and object tracking system of the present invention comprises a first fusion module and a second fusion module. The first fusion module performs a first fusion process on a 2D driving image and 3D point cloud information to obtain first fusion information containing a plurality of recognized objects. The second fusion module is connected the first fusion module. The second fusion module performs a second fusion process on the first fusion information and 2D radar information to obtain a second fusion information containing the plurality of recognized objects. The second fusion information is used to generate a region of interest (ROI). The plurality of recognized objects inside ROI are used as the plurality of target objects of subsequent detection and tracking.

In one embodiment of the present invention, the sensor fusion and object tracking system further comprises an object tracking module. The object tracking module is connected to the second fusion module and receives the second fusion information. The object tracking module generates a region of interest (ROI) within the field of view (FOV) of the 2D radar information, and identifies the plurality of recognized objects inside ROI as the plurality of target objects.

In one embodiment of the present invention, the object tracking module performs a centroid tracking algorithm on the target objects inside ROI, whereby to generate a target centroid coordinates of each target object. The object tracking module performs a Kalman filter on the target centroid coordinates of each target object to obtain observed information of each target object and calculates predicted information based on the observed information. The object tracking module uses the observed information and the predicted information to track target objects.

In one embodiment of the present invention, the second fusion module performs a high-pass filter and a low-pass filter to filter out the noise of the second fusion information.

In one embodiment of the present invention, the first fusion information is the space information of external environment.

In one embodiment of the present invention, the first fusion module is further configured to perform feature extraction using a neural network on the 2D driving image and the 3D point cloud information to obtain a plurality of characteristic points.

The present invention also provides a sensor fusion and object tracking method, which comprises steps:
receiving a 2D driving image and 3D point cloud information and performing a first fusion process on the 2D driving image and the 3D point cloud information by a first fusion module to obtain first fusion information containing a plurality of recognized objects; and receiving 2D radar information and performing a second fusion process on the first fusion information and the 2D radar information by a second fusion module to obtain second fusion information containing the recognized objects, wherein the second fusion information is used to generate a region of interest; the recognized objects inside the region of interest is used as a plurality of target objects for subsequent tracking.

In one embodiment of the present invention, the sensor fusion and object tracking method further comprises a step: by using an object tracking module, receiving the second fusion information, generating the region of interest within a field of view of the 2D radar information according to the second fusion information, and identifying the recognized objects inside the region of interest as the target objects.

In one embodiment of the present invention, further comprising the following steps by using the object tracking module: performing a centroid tracking algorithm to generate a target centroid coordinates of each target object; performing Kalman filter on the target centroid coordinates of each target object to obtain observed information, and using the observed information to calculate predicted information; and tracking the target objects according to the observed information and the predicted information.

In one embodiment of the present invention, the step of performing the second fusion process further includes a step: performing a high-pass filter and a low-pass filter to filter out noise of the second fusion information by using the second fusion module.

In one embodiment of the present invention, the first fusion information is the space information of the external environment.

In one embodiment of the present invention, the first fusion process further includes a step: performing feature extraction, by the first fusion module using a neural network, on the 2D driving image and the 3D point cloud information to obtain a plurality of characteristic points.

In summary, the sensor fusion and object tracking system and the method thereof can use two fusion processes to achieve the technical efficacy of tracking objects stably.

Thereinafter, the present invention will be described in detail with embodiments and attached drawings to enable the persons having ordinary knowledge of the art to further understand the objectives, technical contents, characteristics, and accomplishments of the present invention.

### BRIEF DESCRIPTION OF THE DRAWINGS

FIG. 1 is a block diagram schematically showing a sensor fusion and object tracking system according to one embodiment of the present invention.

FIG. 2 is a flowchart of a sensor fusion and object tracking method according to one embodiment of the present invention.

FIG. 3 is a block diagram schematically showing a sensor fusion and object tracking system according to another embodiment of the present invention.

FIG. 4 is a flowchart of a sensor fusion and object tracking method according to another embodiment of the present invention.

FIG. 5 is a flowchart of sub-steps of the sensor fusion and object tracking method shown in FIG. 4.

FIG. 6 is a diagram schematically showing the sub-step of performing a centroid tracking algorithm of FIG. 5.

FIG. 7 is a diagram schematically showing a process of performing Kalman filter of FIG. 5

### DETAILED DESCRIPTION OF THE INVENTION

The embodiments of the present invention will be further demonstrated in details hereinafter in cooperation with the corresponding drawings. In the drawings and the specification, the same numerals represent the same or the like elements as much as possible. For simplicity and convenient labeling, the shapes and thicknesses of the elements may be exaggerated in the drawings. It is easily understood: the elements belonging to the conventional technologies and well known by the persons skilled in the art may be not particularly depicted in the drawings or described in the specification. Various modifications and variations made by the persons skilled in the art according to the contents of the present invention are to be included by the scope of the present invention.

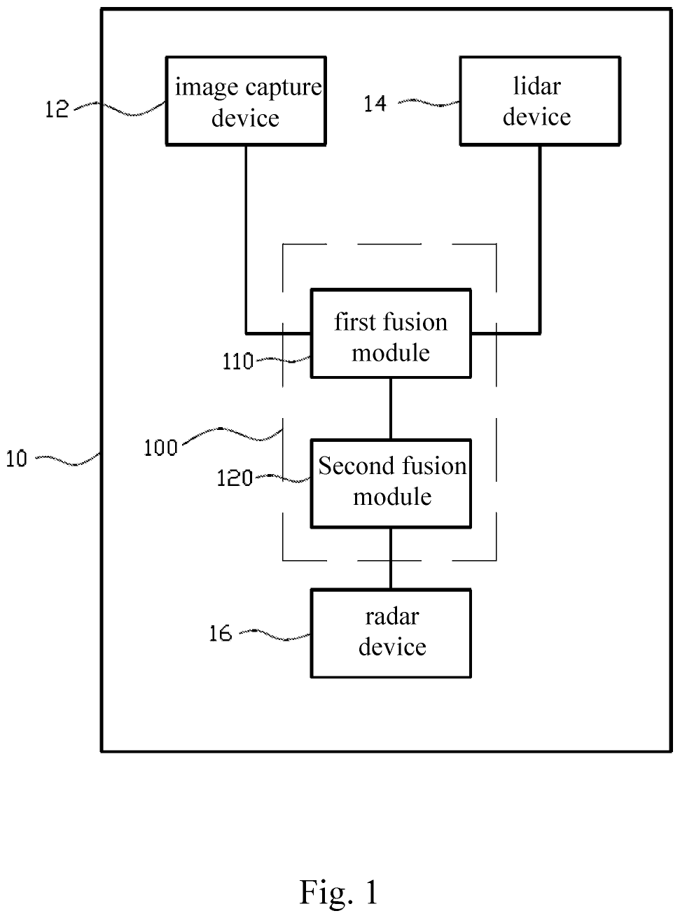

FIG. 1 is a block diagram schematically showing a sensor fusion and object tracking system according to one embodiment of the present invention. Refer to FIG. 1. The sensor fusion and object tracking system 100 comprises a first fusion module 110 and a second fusion module 120, which may be but are not limited to be realized by a processing device (not shown in the drawing) and cooperative software or other hardware. The processing device may include a processing unit and a storage unit. The processing unit may be selected from a group containing central processing units (CPU), application processors (AP), general-purpose programmable microprocessors, digital signal processors (DSP), image signal processors (ISP), graphics processing units (GPU), other appropriate devices/ICs, and combinations thereof. The storage unit is a stationary or mobile memory, which is selected from a group containing random access memories (RAM), read-only memories (ROM), flash memories, hard discs, other appropriate devices/ICs, and combinations thereof.

The sensor fusion and object tracking system 100 may be installed in a vehicle 10 and integrated with an autonomous driving system (not shown in the drawing). The vehicle 10 may include an image capture device 12, a lidar device 14, and a radar device 16. The first fusion module 110 is connected with the image capture device 12 and the lidar device 14 to respectively receive a 2D driving image and 3D point cloud information from the image capture device 12 and the lidar device 14. The first fusion module 110 performs a first fusion process of the 2D driving image and the 3D point cloud information to obtain first fusion information containing a plurality of recognized objects. The recognized objects may be other vehicles around the vehicle 10. In the embodiment, the first fusion information may be space information of the external environment, such as the positions and types of the barriers (including surrounding vehicles), wherein the types of the barriers may be motorcycles, automobiles, trucks, etc.

The second fusion module 120 is in signal communication with the first fusion module 110 and the radar device 16 to respectively receive the first fusion information and 2D radar information from the first fusion module 110 and the radar device 16. The second fusion module 120 performs a second fusion process of the first fusion information and the 2D radar information to obtain second fusion information containing the recognized objects. The second fusion information is used to generate a region of interest (ROI). The recognized objects inside ROI are used as the target objects of subsequent detection and tracking. The second fusion information includes the positions and speeds of the recognized objects appearing at farther locations. The first fusion information generated by the first fusion process is the near-range information. The radar device 16 may perform longer-range detection. Therefore, the second fusion process incorporates the radar information into the second fusion information, wherein the objects at farther places and the speeds of the objects are added to the second fusion information, whereby to compensate for the smaller coverage of the first fusion information.

It deserves to be mentioned particularly: in the sensor fusion and object tracking system 100, the first fusion module 110 fuses the high-dimensional 2D driving image and 3D point cloud information to acquire high-precision and high-correctness results; the second fusion module 120 fuses the low-dimensional 2D radar information to compensate for the blind zone of detection.

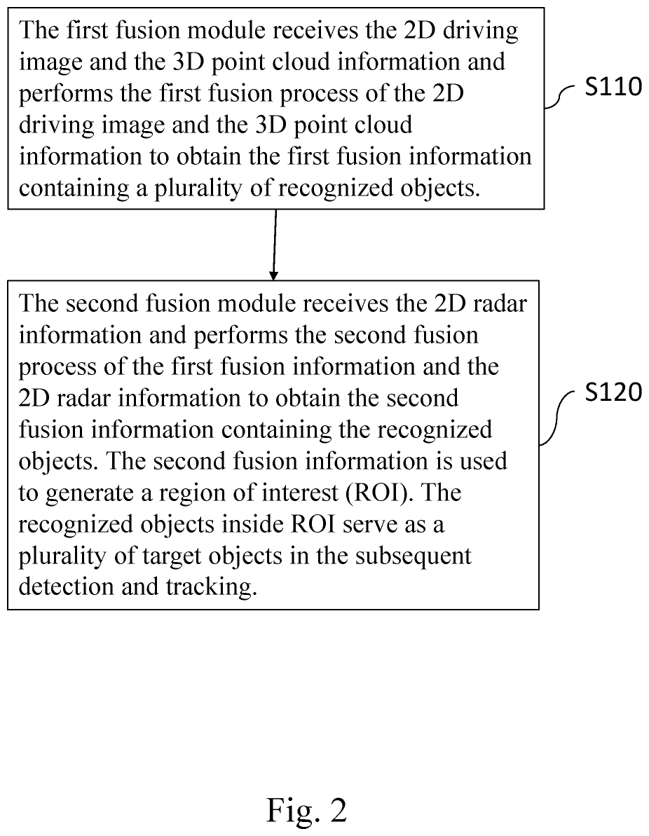

FIG. 2 is a flowchart of a sensor fusion and object tracking method according to one embodiment of the present invention. Refer to FIG. 2. For convenience, the method is described in cooperation with the sensor fusion and object tracking system 100 shown in FIG. 1. Firstly, in Step S110, the first fusion module 110 receives the 2D driving image and the 3D point cloud information and performs the first fusion process of the 2D driving image and the 3D point cloud information to obtain the first fusion information containing a plurality of recognized objects. For example, the first fusion module 110 is further configured to perform feature extraction using a neural network on the 2D driving image and the 3D point cloud information to obtain a plurality of characteristic points; next, the first fusion module 110 determines frame of the recognized objects according to the characteristic points; then, the first fusion module 110 performs the first fusion process on the selected recognized objects to obtain the first fusion information, which contains the related information of the recognized objects, such as the positions, speeds, and types (e.g. humans, vehicles, and barriers).

To demonstrate it in details, in the first fusion process, the first fusion module 110 selects the recognized objects by the plurality of characteristic points from the 2D driving image and then performs the fusion process of the 3D point cloud information maps to the selected recognized objects in the 2D driving image. The neural network, which is used by the first fusion module 110 to perform feature extraction characteristic points from the 2D driving image, may be the CNN, R-CNN, RNN, ResNet or Seq2Seq (Sequence to Sequence) neural network. The neural network, which is used by the first fusion module 110 to perform feature extraction from the 3D point cloud information, may be the PointNet or Voxel-based neural network. Alternatively, the neural network, which is used by the first fusion module 110 to perform feature extraction from the 2D driving image and the 3D point cloud information, may be any one of the neural network models mentioned above. However, the present invention is not limited by the abovementioned embodiments.

The fusion method that the 3D point cloud information maps to the recognized objects in the 2D driving image may be realized by using the K-means clustering method to obtain the correspondence of the characteristic points of the 2D driving image and the characteristic points of the 3D point cloud information, wherein the K-means algorithm performs to corresponding to the 2D driving image and the characteristic points of the 3D point cloud information and divides the characteristic points of the 2D driving image and the characteristic points of the 3D point cloud information into K clusters, wherein K is the preset number of the clusters. Each cluster represents a correspondence relationship. The K-means algorithm is to find a cluster center of the characteristic points, whereby the average distance of the members of the cluster is minimal. The cluster centers are some special points in the image, such as critical points. According to the positions of the cluster centers, the correspondence of the characteristic points of the 2D driving image and the characteristic points of the 3D point cloud information is established, which may be realized via searching for the nearest 2D characteristic point around each cluster center.

The measure of mapping the characteristic points of the 2D driving image to the characteristic points of the 3D point cloud information may be realized by using the Point Cloud Registration method, such as the Iterative Closest Point (ICP) algorithm to map the 3D point cloud to the 2D image, wherein the optimized transformation is found out to realize the correspondence of both. However, the present invention does not constrain that mapping must be realized with the abovementioned K-means algorithm or ICP algorithm.

Next, Step S120 is executed. In Step S120, the second fusion module 120 receives the 2D radar information and performs the second fusion process of the first fusion information and the 2D radar information to obtain the second fusion information containing the recognized objects. The second fusion information is used to generate a region of interest (ROI). The recognized objects inside ROI serve as a plurality of target objects in the subsequent detection and tracking. In the embodiment, the second fusion module 120 may further use a high-pass filter, a low-pass filter, or a band-pass filter to filter out the noise of the second fusion information. In the case that the driving vehicle detects the surround environment to generate the recognized objects, the first fusion information contains the recognized objects in near range, and the 2D radar information adds the information of the farther recognized objects, such as the positions and speeds thereof, to compensate for the blind zone of the first fusion information.

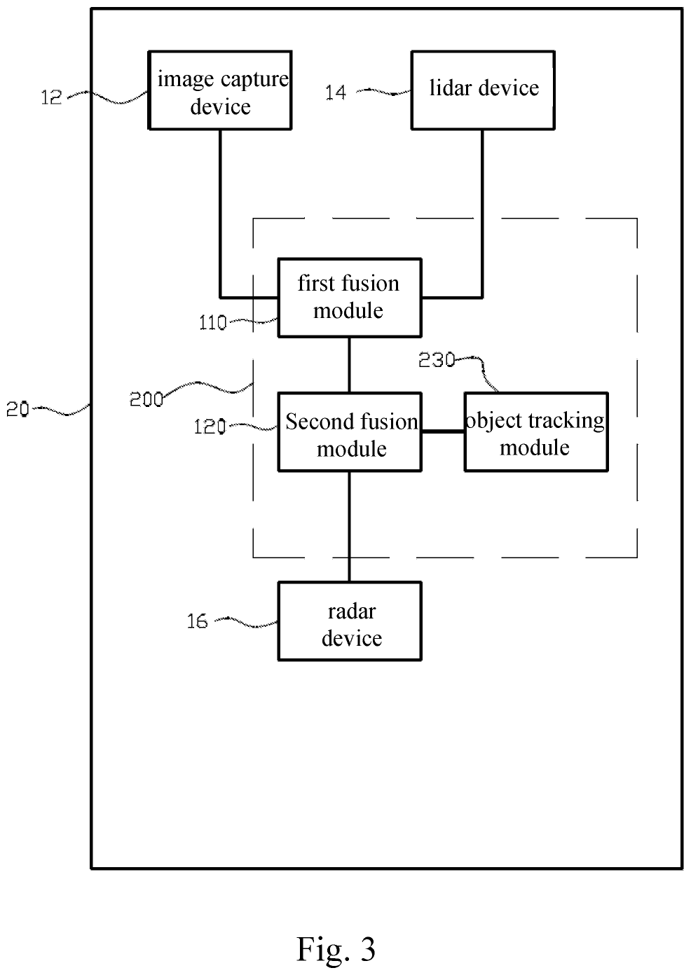

FIG. 3 is a block diagram schematically showing a sensor fusion and object tracking system according to another embodiment of the present invention. Refer to FIG. 1 and FIG. 3. In the embodiment, the vehicle 20 is similar to the vehicle 10, but the sensor fusion and object tracking system 200 is different from the sensor fusion and object tracking system 100 in that the sensor fusion and object tracking system 200 further comprises an object tracking module 230. The like elements in FIG. 3 are designated with the same numerals used in FIG. 1 and will not repeat herein. The object tracking module 230 is in signal communication with the second fusion module 120 and receives the second fusion information. The object tracking module 230 generates a region of interest (ROI) in the second fusion information within the field of view of the 2D radar information, and identifies the recognized objects inside ROI as target objects.

In the embodiment, the object tracking module 230 performs a centroid tracking algorithm on the target objects inside ROI, whereby to generate a target centroid coordinates of each target object. The object tracking module 230 performs a Kalman filtering process on the target centroid coordinates of each target objects to obtain observed information of each target objects and calculates predicted information based on the observed information. The object tracking module 230 uses the observed information and the predicted information to track the target objects.

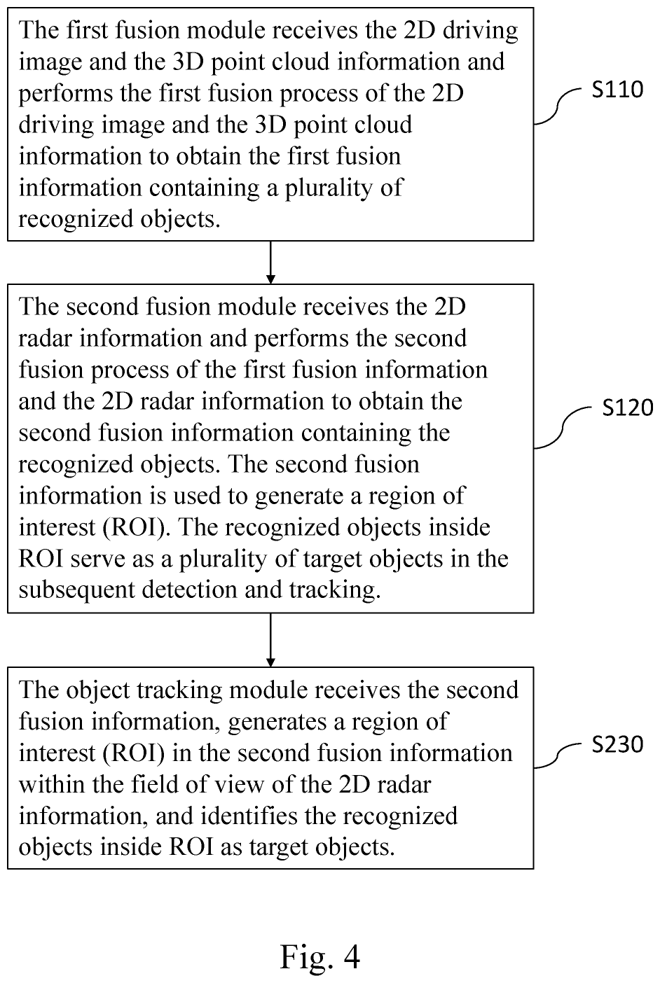

FIG. 4 is a flowchart of a sensor fusion and object tracking method according to another embodiment of the present invention. Refer to FIG. 3 and FIG. 4. For convenience, the method is described in cooperation with the sensor fusion and object tracking system 200 shown in FIG. 3. The sensor fusion and object tracking method shown in FIG. 4 is similar to the sensor fusion and object tracking method shown in FIG. 2, and the like steps are labeled with the same notations and will not repeat herein. In addition to the steps shown in FIG. 2, the sensor fusion and object tracking method shown in FIG. 4 further comprises a Step S230. In Step S230, the object tracking module 230 receives the second fusion information, generates a region of interest (ROI) in the second fusion information within the field of view of the 2D radar information, and identifies the recognized objects inside ROI as target objects.

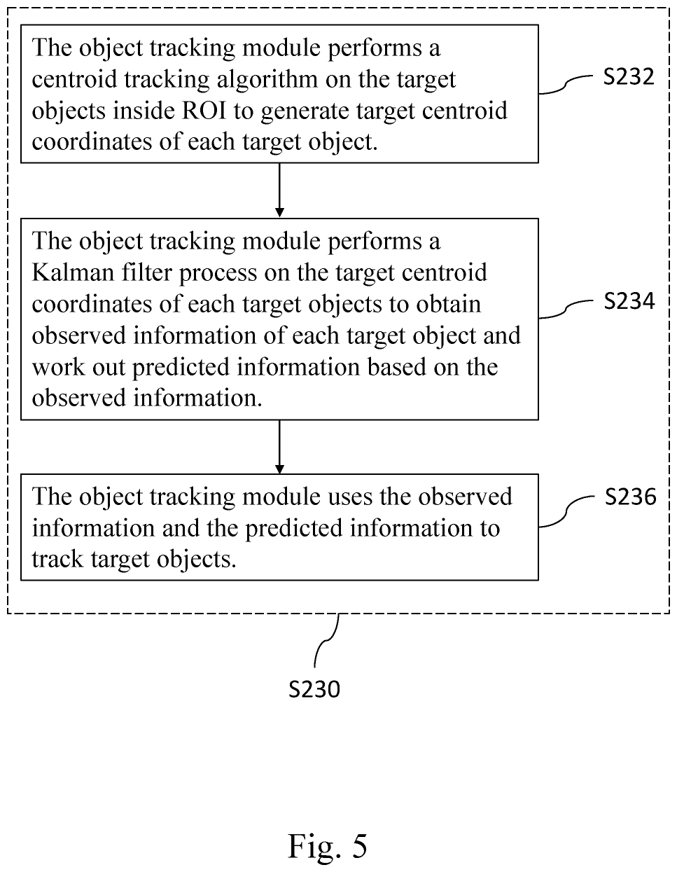

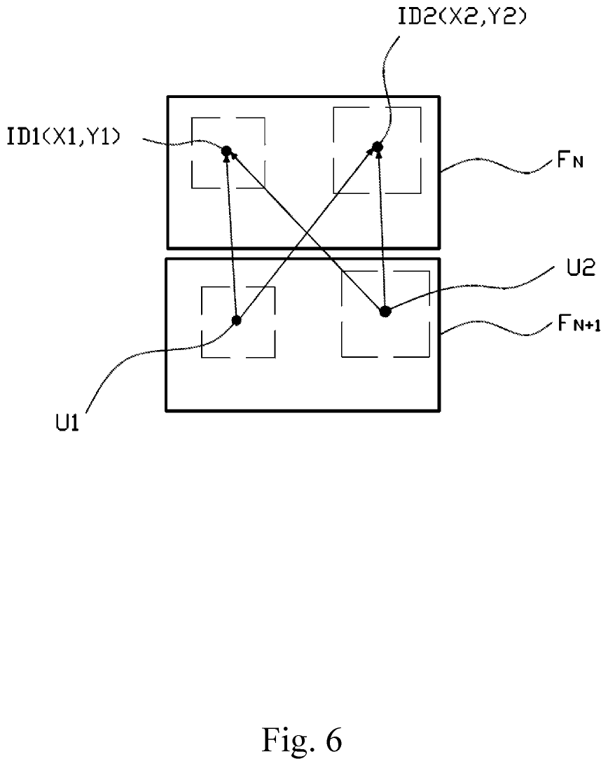

FIG. 5 is a flowchart of the sub-steps of the step of detecting and tracking a plurality of objects in ROI in FIG. 4. Refer to FIG. 4 and FIG. 5, Step S230 includes Sub-steps S232-S236. Firstly, Step S232 is executed. In Step S232, the object tracking module 230 performs a centroid tracking algorithm on the target objects inside ROI to generate a target centroid coordinates of each target object. FIG. 6 is a diagram schematically showing the sub-step of performing a centroid tracking algorithm of FIG. 5. Refer to FIG. 6. The image F_{N} of the Nth frame and the image F_{N+1} of the (N+1)th Frame are schematically depicted in FIG. 6, wherein the centroids ID1 and ID2 of the target objects and the unknown centroids U1 and U2 are shown in FIG. 6. Firstly, in the image F_{N} of the Nth frame, the object tracking module 230 calculates the centroids of the target objects and obtains the coordinates of the centroids ID1 and ID2, which are respectively expressed by (X1, Y1) and (X2, Y2). Next, the object tracking module 230 calculates the Euclidean distance of the unknown centroids U1 and U2 in the image F_{N+1} of the (N+1)th Frame and the Euclidean distance of the centroids ID1 and ID2 of the target objects in the image F_{N} of the Nth frame. Next, according to the calculated Euclidean distances, the object tracking module 230 determines whether the unknown centroids U1 and U2 are identical to the centroids ID1 and ID2 of the target objects. If the object tracking module 230 determines that the unknown centroids U1 and U2 are respectively identical to the centroids ID1 and ID2 of the target objects, the unknown centroids U1 and U2 are respectively labeled with the same notations ID1 and ID2 and respectively further configured to perform feature extraction. After the designation of the notations ID1 and ID2, the object tracking module 230 joins the former Nth frame of image F_{N} and the image F_{N+1} of the latter (N+1)th Frame together. In the abovementioned calculation, suppose that there two points p1 and p2 in space, whose coordinates are respectively (x1, y1) and (x2, y2). The Euclidean distance of the point p1 and the point p2 may be calculated according to the following equation:

$$d ( p 1 , p 2 ) = \sqrt{{( x 1 - x 2 )}^{2} + {( y 1 - y 2 )}^{2}}$$

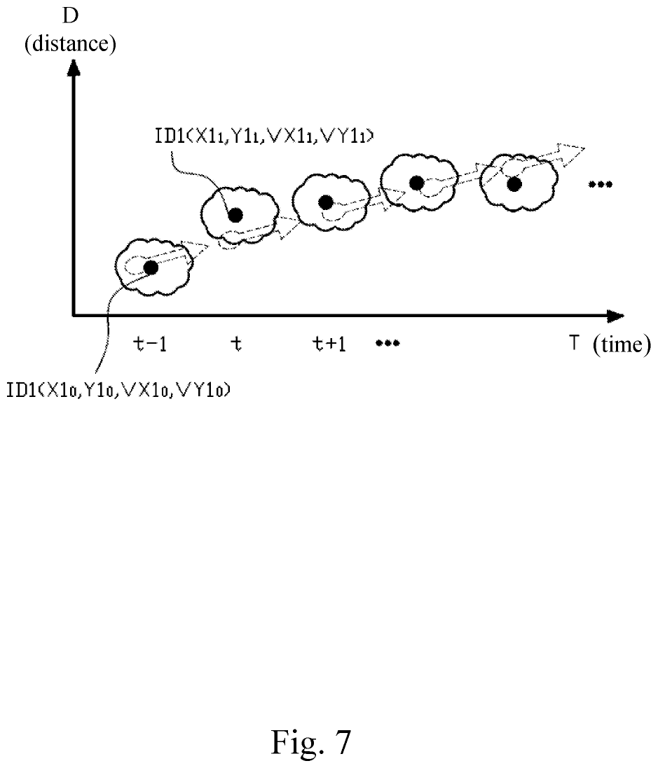

Next, Step S234 is executed to perform a Kalman filter process on the target centroid coordinates of each target objects to obtain observed information and calculate predicted information based on the observed information. FIG. 7 is a diagram schematically showing a process of performing Kalman filter of FIG. 5. Refer to FIG. 7. Firstly, acquire the centroid ID1 of one of the target objects, and acquire the coordinates and speed of the centroid ID1 and perform Kalman tracking. Next, acquire the positional information (X1₀, Y1₀) and the speed information (VX1₀, VY1₀) of the centroid of ID1 at the time point “t−1” in the time axis, i.e. the observed information—the values acquired physically. Next, use the information of the centroid ID1 (X1₀, Y1₀, VX1₀, VY1₀) to predict the information of the next frame, i.e. predict that the positional information and the speed information of the centroid ID1 at the time point “t” in the time axis is (X1₁, Y1₁, VX1₁, VY1₁), i.e. the predicted information. Finally, Step S236 is executed, wherein the object tracking module 230 uses the observed information and the predicted information to track target objects. Via the abovementioned centroid tracking method and the Kalman filtering for multi-object tracking method, the present invention can overcome the problem of distance error generated by fast-moving the recognized object. Therefore, while there is a plurality of moving recognized objects (vehicles), the present invention can upgrade the accuracy of object detection and enhance the stability of object tracking. Thus is promoted the reliability of the sensor fusion and object tracking system.

The present invention is not limited to use the centroid tracking algorithm and the Kalman filter algorithm to track a plurality of target objects in ROI. In some embodiments of the present invention, a particle filtering method is used to track a plurality of target objects, wherein a characteristic point (such as the abovementioned critical point) is used as a tracked particle to simulate the possible position of a target, and then resampling and reweighting is performed to track objects. In some embodiments of the present invention, a Hungarian Algorithm/Linear Assignment algorithm is used to track objects, wherein the relationships between the objects and the trajectories are established to track a plurality of objects. In some embodiments of the present invention, a Multiple Hypothesis Tracking method is used to track objects, wherein a plurality of possible trajectories is established; the possible trajectories are weighted according to the observed values to find the most possible trajectory. In some embodiments of the present invention, a deep-learning technology, such as the Recurrent Neural Network (RNN) or a Long Short Term Memory (LSTM) network, is used to learn the motion models so as to track objects more precisely. In other words, the most critical task of the object tracking module 230 is to use any one of the abovementioned methods to add the boundary frames to the recognized objects quickly and accurately.

In conclusion, the object tracking system and the method thereof adopt a strategy of integrating high-dimensional information (generated in the first fusion process) with low-dimensional information (added in the second fusion process) to reduce information loss, expand detection range, extend FOV, and upgrade precision. In other words, the high-dimensional information can maintain its precision within the effective range thereof in the first fusion process; the information, which is not involved in the high-dimensional fusion, is used to compensate for the blind zone in the second fusion process. In some embodiments, the information obtained with multiple sensors beforehand is filtered to reduce noise, whereby to enhance instantaneity and correctness and reduce the computation resource required by fusion. Besides, the algorithms used by the abovementioned embodiments can increase the detection correctness and tracking stability and thus can enhance the overall stability of the multi-sensor fusion system.

The embodiments described above are to demonstrate the technical thought and characteristics of the present invention to enable the persons skilled in the art to understand, make, and use the present invention. However, these embodiments are only to exemplify the present invention but not to limit the scope of the present invention. Any equivalent modification or variation according to the spirit of the present invention is to be also included by the scope of the present invention.

What is claimed is:

1. A sensor fusion and object tracking system, comprising
a first fusion module configured to perform a first fusion process on a 2D driving image and 3D point cloud information to obtain first fusion information containing a plurality of recognized objects; and
a second fusion module, being in signal communication with the first fusion module, the second fusion module being configured to perform a second fusion process on the first fusion information and 2D radar information to obtain second fusion information containing the recognized objects,
wherein the second fusion information is used to generate a region of interest (ROI); the recognized objects inside the region of interest are used as a plurality of target objects of subsequent detection and tracking.

2. The sensor fusion and object tracking system according to claim 1, further comprising
an object tracking module being in signal communication with the second fusion module, receiving the second fusion information, generating the region of interest within a field of view (FOV) of the 2D radar information according to the second fusion information, and identifying the recognized objects inside the region of interest as the target objects.

3. The sensor fusion and object tracking system according to claim 2, wherein the object tracking module is further configured to:
perform a centroid tracking algorithm on the target objects inside the region of interest to generate a target centroid coordinates of each of the target objects;
perform a Kalman filter on the target centroid coordinates of each of the target objects to obtain observed information of each of the target objects and then calculates predicted information based on the observed information; and
track the target objects according to the observed information and the predicted information.

4. The sensor fusion and object tracking system according to claim 1, wherein the second fusion module performs a high-pass filtering process and a low-pass filtering process to filter out noise of the second fusion information.

5. The sensor fusion and object tracking system according to claim 1, wherein the first fusion information is space information of external environment.

6. The sensor fusion and object tracking system according to claim 1, wherein the first fusion module is further configured to perform feature extraction using a neural network on the 2D driving image and the 3D point cloud information to obtain a plurality of characteristic points.

7. A sensor fusion and object tracking method, comprising steps:
receiving a 2D driving image and 3D point cloud information and performing a first fusion process on the 2D driving image and the 3D point cloud information by a first fusion module to obtain first fusion information containing a plurality of recognized objects; and
receiving 2D radar information and performing a second fusion process on the first fusion information and the 2D radar information by a second fusion module to obtain second fusion information containing the recognized objects,
wherein the second fusion information is used to generate a region of interest, the recognized objects inside the region of interest is identified as a plurality of target objects for subsequent tracking.

8. The sensor fusion and object tracking method according to claim 7, further comprising a step:
by using an object tracking module, receiving the second fusion information, generating the region of interest within a field of view of the 2D radar information according to the second fusion information, and identifying the recognized objects inside the region of interest as the target objects.

9. The sensor fusion and object tracking method according to claim 8, further comprising the following steps by using the object tracking module:
performing a centroid tracking algorithm to generate a target centroid coordinates of each of the target objects;
performing Kalman filtering on the target centroid coordinates of each of the target objects to obtain observed information, and using the observed information to calculate predicted information; and
tracking the target objects according to the observed information and the predicted information.

10. The sensor fusion and object tracking method according to claim 7, wherein the step of performing the second fusion process further includes a step:
performing a high-pass filtering process and a low-pass filtering process to filter out noise of the second fusion information by using the second fusion module.

11. The sensor fusion and object tracking method according to claim 7, wherein the first fusion information is space information of external environment.

12. The sensor fusion and object tracking method according to claim 7, wherein the first fusion process further includes a step:
performing feature extraction, by the first fusion module using a neural network, on the 2D driving image and the 3D point cloud information to obtain a plurality of characteristic points.
